(19) United States
(12) Patent Application Publication
(10) Pub. No.: US 2016/0009163 A1
(43) Pub. Date: Jan. 14, 2016

(54) AIR CONDITIONING THIN REGISTER

(71) Applicant: TOYODA GOSEI CO., LTD., Kiyosu-shi (JP)

(72) Inventors: Nobuhiro TERAI, Kiyosu-shi (JP); Kenji ASANO, Nagoya-shi (JP)

(21) Appl. No.: 14/747,258

(22) Filed: Jun. 23, 2015

(30) Foreign Application Priority Data
Jul. 9, 2014 (JP) 2014-141580

(51) Int. Cl. B60H 1/34

(52) U.S. Cl. CPC B60H 1/3421

(57) ABSTRACT

An air conditioning thin register includes: a case including a blow-out opening for the air-conditioning air; a pair of auxiliary fins provided in portions of the interior of the case which are adjacent to the second walls; and a main fin extending in the first direction between the paired auxiliary fins, the two auxiliary fins being inclined similarly to and synchronously with the main fin, wherein the second walls include in their downstream portions swelling wall portions swelling in a direction to go away from the ventilation passage, a space surrounded by the swelling wall portions constitutes an inclination space allowing the auxiliary fins to incline more outwardly of the ventilation passage than ordinary wall portions; and the dimension of the blow-out opening in the second dimension and the distance between the ordinary wall portions of the paired second walls are set equal or approximate to each other.

### CROSS-REFERENCE TO RELATED APPLICATION(S)

This application is based upon and claims the benefit of priority from Japanese Patent Application No. 2014-141580, filed on Jul. 9, 2014, the entire contents of which are incorporated herein by reference.

### BACKGROUND

1. Field of the Invention

The invention relates to an air conditioning thin register which includes in its downstream end a rectangular-shaped opening serving as an air blow-out opening of air-conditioning air fed from an air conditioner and, using fins, changes the direction of the air-conditioning air to be blown from the opening.

2. Description of the Related Art

The instrument panel of a vehicle incorporates therein an air conditioning register for changing the direction of air conditioning air fed from an air conditioner and blown into a vehicle room. This air conditioning register, conventionally, includes various thin air conditioning registers (which are hereinafter called air conditioning thin registers) of a type that the longitudinal- and transverse-direction dimensions thereof differ greatly from each other, for example, a type that the transverse-direction dimension is larger than the longitudinal-direction.

An example of this type of air conditioning thin register includes a case, a pair of auxiliary fins and a main fin. The case has a short-height square cylindrical shape and has an internal space serving as a ventilation passage for the air-conditioning air. The case also has a blow-out opening for the air-conditioning air in its downstream end. The blow-out opening, from the viewpoint of design, has a rectangular shape in which the longitudinal-direction dimension is smaller than the transverse-direction dimension.

The auxiliary fins and the main fin interposed between them respectively extend transversely and are supported such that they can be inclined with respect to the right and left walls of the case by fin shafts. The air-conditioning air flowing through the ventilation passage, after flowing along the main and auxiliary fins, blows out from the blow-out opening.

The above air conditioning thin register, from the viewpoint of the arrangement and operation modes of the auxiliary fins, is generally classified to two types.

In an air conditioning thin register of a type shown in FIG. 9, two auxiliary fins 76 are inclined in linking with a main fin 75. Thus, the upper wall 74 of the case 71 is separated upward from the fin shaft 77 of the upper auxiliary fin 76 in order to secure the inclination space of the upper auxiliary fin 76. The lower wall 74 of the case 71 is separated downward from the fin shaft 77 of the lower auxiliary fin 76 in order to secure the inclination space of the lower auxiliary fin 76 (for example, see JP-A-2013-116650).

Also, in an air conditioning thin register of a type shown in FIG. 10, as shown by solid lines in FIG. 10, when the main fin 75 is set parallel to the upper and lower walls 74, the two auxiliary fins 76 are set parallel to the walls 74. When the main fin 75 is inclined from the above state, for example, as shown by two-dot chain lines in FIG. 10, the auxiliary fin 76 near to the upstream end of the main fin 75 (in FIG. 10, the upper auxiliary fin 76) is maintained parallel to the wall 74. Also, the auxiliary fin 76 remote from the upstream end of the main fin 75 (in FIG. 10, the lower auxiliary fin 76), as shown by two-dot chain lines in FIG. 10, is inclined in the same direction of the main fin 75 synchronously therewith (for example, see JP-A-2011-27348). In this type of air conditioning thin register, the auxiliary fins 76 are not inclined to the side distant from a ventilation passage 73. Therefore, the upper wall 74 of the case 71 is disposed near to the fin shaft 77 of the upper auxiliary fin 76. Also, the lower wall 74 of the case 71 is disposed near to the fin shaft 77 of the lower auxiliary fin 76.

However, in the former type (FIG. 9) air conditioning thin register, as described above, since the upper wall 74 is separated upward from the fin shaft 77 of the upper auxiliary fin 76 and the lower wall 74 is separated downward from the fin shaft 77 of the lower auxiliary fin 76, the distance D1 between the two walls 74 is large. Meanwhile, as described above, the vertical-direction dimension M1 of the blow-out opening 72 is smaller than the right-and-left direction dimension thereof. Thus, the difference between the vertical-direction dimension M1 of the blow-out opening 72 and the distance D1 between the two walls 74 is large. This means that, while the air-conditioning air A1 is passing the main fin 75 and two auxiliary fins 76 parallel to the two walls 74, the vertical-direction dimension of the passage is suddenly reduced. Consequently, when the main fin 75 and two auxiliary fins 76 are set parallel to the walls 74, ventilation resistance increases to thereby increase pressure loss.

Meanwhile, in the latter type (FIG. 10) air conditioning thin register, the distance D1 between the two walls 74 is smaller than in the former type (FIG. 9). The difference between the vertical-direction dimension M1 of the blow-out opening 72 and the distance D1 between the two walls 74 is smaller than in the former type (FIG. 9) air-conditioning thin register. However, as shown by two-dot chain lines in FIG. 10, when the main fin 75 is inclined with respect to the two walls 74, since the auxiliary fin 76 near to the upstream end of the main fin 75 (in FIG. 10, the upper auxiliary fin 76) is set parallel to the wall 74, the vertical-direction dimension of the passage 78 between the auxiliary fin 76 and main fin 75 is small. Therefore, when the air-conditioning air A1 passes through the passage 78, ventilation resistance is large and, in this case as well, pressure loss increases. Also, the distance D4 between the main fin 75 and the auxiliary fin 76 (in FIG. 10, the lower side fin) remote from the upstream end thereof is extremely small, thereby increasing pressure loss abnormally.

When the pressure loss increases in the above manner, in both types shown in FIGS. 9 and 10, noises such as wind noise generated when the air-conditioning air A1 blows out from the blow-off opening 72 are large.

### SUMMARY

The present invention is devised by considering the above-described circumstances, and it is an object of the present invention to provide an air conditioning thin register which can reduce pressure loss regardless of the inclination of the main fin and two auxiliary fins.

According to a first aspect of the invention, there is provided an air conditioning thin register including: a case formed of a pair of first walls opposed to each other in a first direction and a pair of second walls opposed to each other in a second direction into a cylindrical shape with its dimension in the first direction larger than its dimension in the second direction, having an internal space serving as the ventilation passage for an air-conditioning air, and including in the downstream end thereof a blow-out opening for the air-conditioning air; a pair of auxiliary fins provided in portions of the interior of the case which are adjacent to the second walls, extending in the first direction and supported to be inclinable with respect to the first walls; and a main fin extending in the first direction between the paired auxiliary fins and supported to be inclinable with respect to the first walls, the two auxiliary fins being inclined similarly to and synchronously with the main fin, wherein the second walls respectively include in their downstream portions swelling wall portions swelling in a direction to go away from the ventilation passage, a space surrounded by the swelling wall portions constitutes an inclination space allowing the auxiliary fins to incline more outwardly of the ventilation passage than ordinary wall portions constituting the portions of the second walls existing more upstream of the swelling wall portions; and the dimension of the blow-out opening in the second dimension and the distance between the ordinary wall portions of the paired second walls are set equal or approximate to each other.

According to the above structure, when the main fin is set parallel to the ordinary wall portions of the second walls, the auxiliary fins, in portions near to the second walls, are parallel to the ordinary wall portions. Part of the air-conditioning air, in the passage between the main fin and auxiliary fins, flows along the main and auxiliary fins and blows out downward straight from the blow-out opening. Here, since the main and auxiliary fins are all parallel to the ordinary wall portions of the second walls, the resultant ventilation resistance is smallest. This ventilation resistance depends on the difference between the dimension of the blow-out opening in the second direction and the distance between the paired ordinary wall portions. However, as described above, since the dimension of the blow-out opening and the distance between the paired ordinary wall portions are set equal or approximate to each other, the difference between them is small. This hardly causes an increase in ventilation resistance which can otherwise occur due to sudden reduction of the passage area when the air-conditioning air flows along the main and auxiliary fins, thereby reducing the pressure loss.

Also, when the main fin is inclined with respect to the ordinary wall portions of the second walls, the auxiliary fin remote from the upstream end of the main fin is inclined inside the ventilation passage (toward the side that is distant from the nearest second wall). That is, the auxiliary fin is inclined similarly to the main fin. Also, the auxiliary fin near to the upstream end of the main fin enters the outside of the ventilation passage, that is, the inclination space of the swelling wall portion of the nearest second wall. This auxiliary fin is also inclined similarly to the main fin. Therefore, differently from the structure that the auxiliary fin near to the upstream end of the main fin is set parallel to the second wall, the dimension of the passage in the second direction between the auxiliary fin and main fin is large. This hardly causes an increase in ventilation resistance which can otherwise occur due to sudden reduction of the passage area when the air-conditioning air flows through the passage between the main fin and the auxiliary fins near to the upstream end of the main fin, thereby reducing the pressure loss.

According to a second aspect of the invention, the auxiliary fins may be supported such that they can be inclined with respect to the first walls between the blow-out opening and the second walls.

According to the above structure, when the main fin is set parallel to the ordinary wall portions of the second walls, the auxiliary fins are also situated between the blow-out opening and second wall portions while they are parallel to the ordinary wall portions. Therefore, when the air conditioning thin register is viewed from the downstream side, the periphery of the blow-out opening is situated in front of the auxiliary fins, whereby the auxiliary fins hide behind the periphery and are hard to be seen.

According to a third aspect of the invention, when the main fin is set parallel to the ordinary wall portions, the auxiliary fins may be set parallel to the ordinary wall portions in boundaries with the ventilation passage of the inclination space.

According to the above structure, when the main fin is set parallel to the ordinary wall portions, the auxiliary fins, in their boundaries with the ventilation passage of the inclination space, are parallel to the ordinary wall portions of the second walls. The inclination space, in the boundary with the ventilation passage of the inclination space, is closed by the auxiliary fins. Thus, the air-conditioning air flowing through the ventilation passage is hard to flow into the inclination space and is allowed to flow through the passage between the auxiliary fins and main fin.

According to a fourth aspect of the invention, when the main fin is inclined by a maximum limit angle, the distance between the two auxiliary fins is set equal or approximate to a maximum limit value.

According to the above structure, the area of the passage between the main and auxiliary fins becomes largest when the main and auxiliary fins are parallel to the ordinary wall portions of the second walls. The passage area reduces as the inclination angle of the main and auxiliary fins with respect to the ordinary wall portions increases. However, as described above, since the distance between the two auxiliary fins when the main fin is inclined by a maximum limit angle is set equal or approximate to a maximum limit value, there is secured a wide passage between the main and auxiliary fins. Also when the main fin is inclined by a maximum limit angle, the ventilation resistance of the air-conditioning air when it flows through the passage between the main and auxiliary fins is small and thus the pressure loss is small.

According to the above air conditioning thin register, pressure loss can be reduced regardless of the inclination of the main and two auxiliary fins.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a perspective view of an embodiment of an air conditioning thin register, with a main fin set substantially horizontal;

FIG. 2 is a right side view of the air conditioning thin register of FIG. 1;

FIG. 3 is an exploded perspective view of some of the composing parts of the air conditioning thin register of FIG. 1;

FIG. 4 is an exploded perspective view of some of the composing parts of the air conditioning thin register of FIG. 1;

FIG. 5 is a flat section view of an air-conditioning thin register according to an embodiment;

FIG. 6A shows a longitudinal section view of the air conditioning thin register of the embodiment in which a main fin is set substantially horizontal, and FIG. 6B shows a partially enlarged longitudinal section view of FIG. 6A;

FIG. 7 is a partially longitudinal section view of the air conditioning thin register in which the main fin of FIG. 6B is inclined such that its height rises toward downstream;

FIG. 8 is a partially longitudinal section view of the air conditioning thin register in which the main fin of FIG. 6B is inclined such that its height lowers toward downstream;

FIG. 9 is a partially longitudinal section view of a conventional air conditioning thin register; and

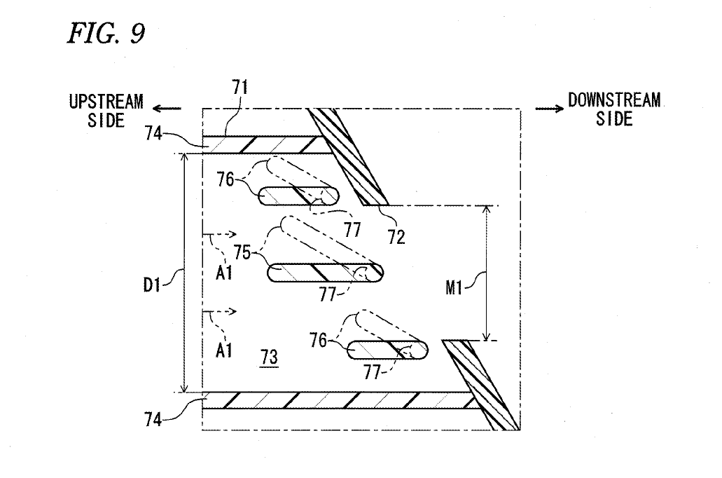

FIG. 10 is a partially longitudinal section view of a conventional air conditioning thin register of a different type from the register of FIG. 9.

### DETAILED DESCRIPTION OF THE INVENTION

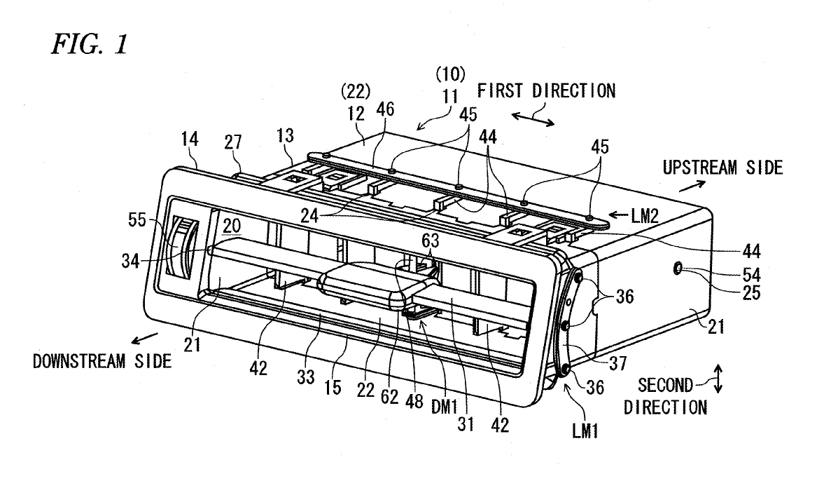

Description is given below of an embodiment of an air conditioning thin register for a vehicle with reference to FIGS. 1 to 8.

Here, in the following description, the advancing direction (forward running direction) of a vehicle is called a forward direction, the retreating direction is called a backward direction, and the vehicle height direction is called a vertical direction. Also, the “vehicle width direction (right-and-left direction)” is defined when the vehicle is viewed from behind.

In front of the front seats (driver's seat and passenger seat) of the vehicle within a vehicle room, there is provided an instrument panel and, in the central, side and other portions of the instrument panel in the vehicle width direction, there is incorporated an air conditioning thin register. The main function of the air conditioning thin register, similarly to an ordinary air conditioning non-thin register, is to change the direction of air-conditioning air supplied from an air conditioner and blown into the vehicle room, to shut the blow-out of the air-conditioning air, and so on.

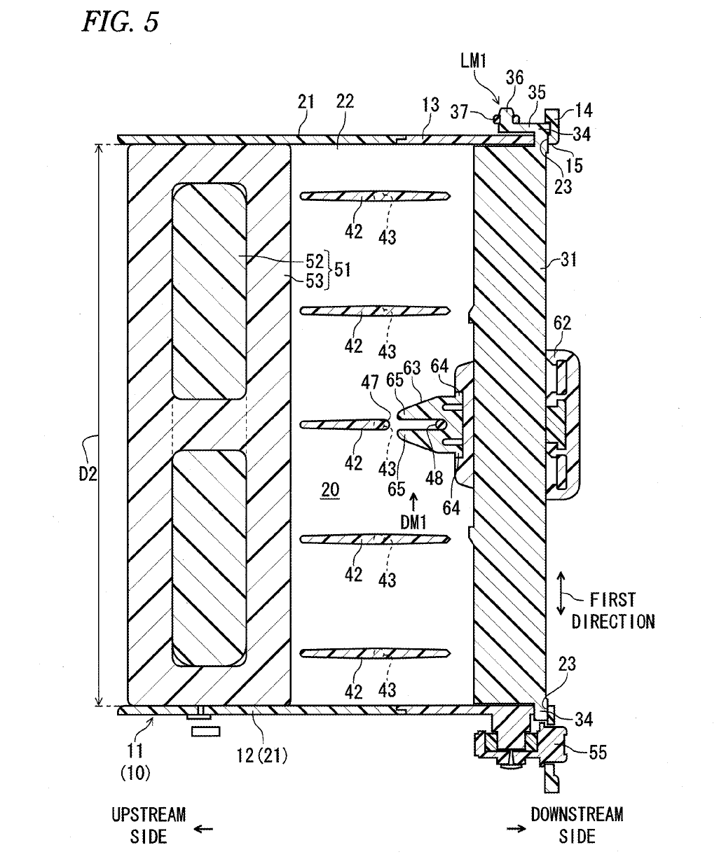

Firstly, description is given of the basic structure of an air conditioning thin register 10. As shown in FIGS. 1 and 5, the register 10 includes a case 11, a downstream side fin group, an upstream side fin group, a shut damper 51, an operation knob 62, and a transmission mechanism DM1. Next, description is given of the structures of the respective composing parts of the register 10.

### <Case 11>

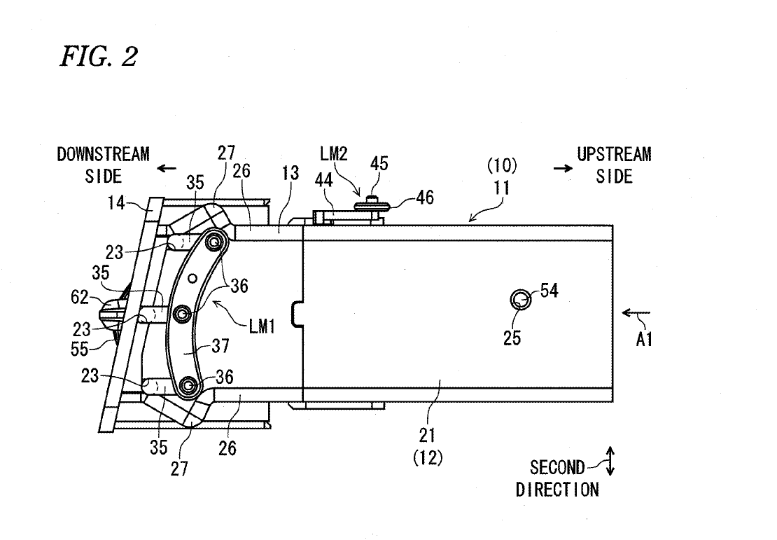

As shown in FIGS. 2 to 4, the case 11 is used to connect the ventilation duct (not shown) of an air conditioner and an opening (not shown) formed in the instrument panel to each other, and includes an upstream side retainer 12, a downstream side retainer 13 and a bezel 14. The case 11 has a square cylindrical shape in which its two ends are opened and its transverse-direction dimension is larger than its longitudinal-direction dimension. The internal space of the case 11 is used as a passage (which is hereinafter called a ventilation passage 20) for an air-conditioning air A1.

Here, on a plane orthogonal to the ventilation direction of the air-conditioning air A1 in the ventilation passage 20, one of two directions substantially orthogonal to each other one is called a first direction, whereas the other is a second direction. In this embodiment, the vehicle width direction is called the first direction, while the vertical direction is called the second direction.

The upstream side retainer 12 constitutes the most upstream side part of the case 11. The downstream side retainer 13 is disposed downstream of the upstream side retainer 12, while the upstream end portion thereof is connected to the downstream end portion of the upstream side retainer 12. The bezel 14 constitutes the design surface of the air conditioning thin register 10, is disposed most downstream in the case 11 and is connected to the downstream side retainer 13 from the downstream side. The bezel 14 has a rectangular-shaped opening. This opening constitutes the downstream end of the ventilation passage 20 and serves as the blow-out opening 15 of the air-conditioning air A1.

The ventilation passage 20 is surrounded by the four walls of the case 11. They are a pair of first walls 21 opposed to each other in the first direction (vehicle width direction) and a pair of second walls 22 opposed to each other in the second direction (vertical direction). The first walls 21 are opposed parallel or approximately parallel to each other, while the distance D2 (see FIG. 5) between the two walls 21 is uniform everywhere in the flow direction of the air-conditioning air A1.

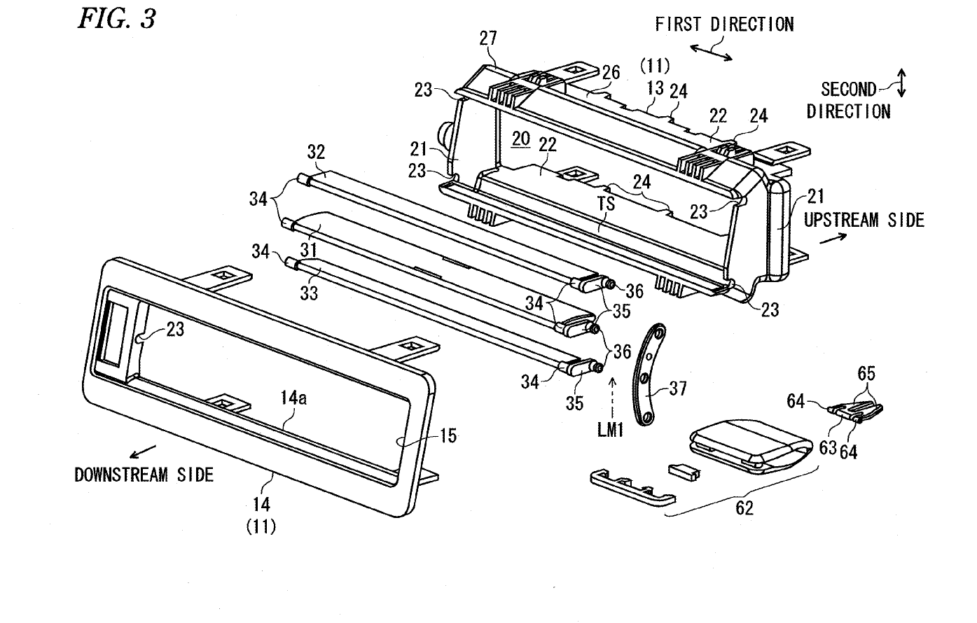

As shown in FIGS. 2 and 3, of the two first walls 21, in multiple portions (upper, central and lower portions) where the downstream end of the downstream side retainer 13 and bezel 14 are connected to each other, there are arranged bearing parts 23 respectively. The upper and lower bearing parts 23, in the second direction, are situated in portions which are adjacent to the second wall 22 and in the upstream vicinity of a projecting part 14a (to be discussed later) provided on the bezel 14.

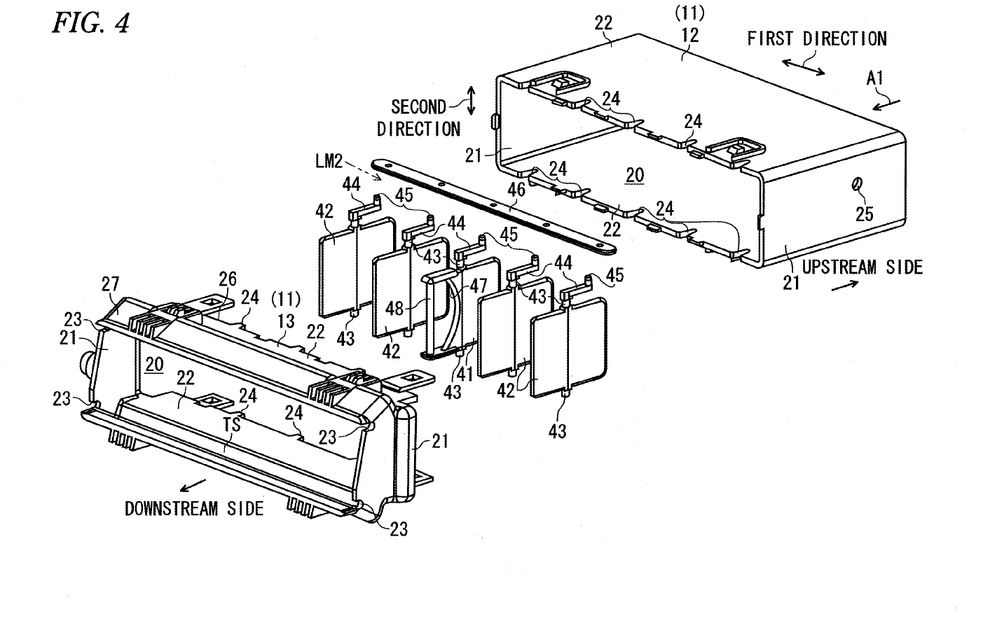

As shown in FIGS. 1 and 4, in such portions of the two second walls 22 as exist upstream of the bearing parts 23, more specifically, in portions where the downstream end of the upstream side retainer 12 and the upstream end of the downstream side retainer 13 are connected to each other, there are provided multiple bearing parts 24. The multiple bearing parts 24, in the first direction, are situated substantially at regular intervals.

In such portions of the respective first walls 21 as exist upstream of the bearing parts 24, there are formed bearing parts 25 respectively constituted of holes. The bearing parts 25, in the second direction, are situated substantially centrally between the second walls 22.

### <Downstream Side Fin Group>

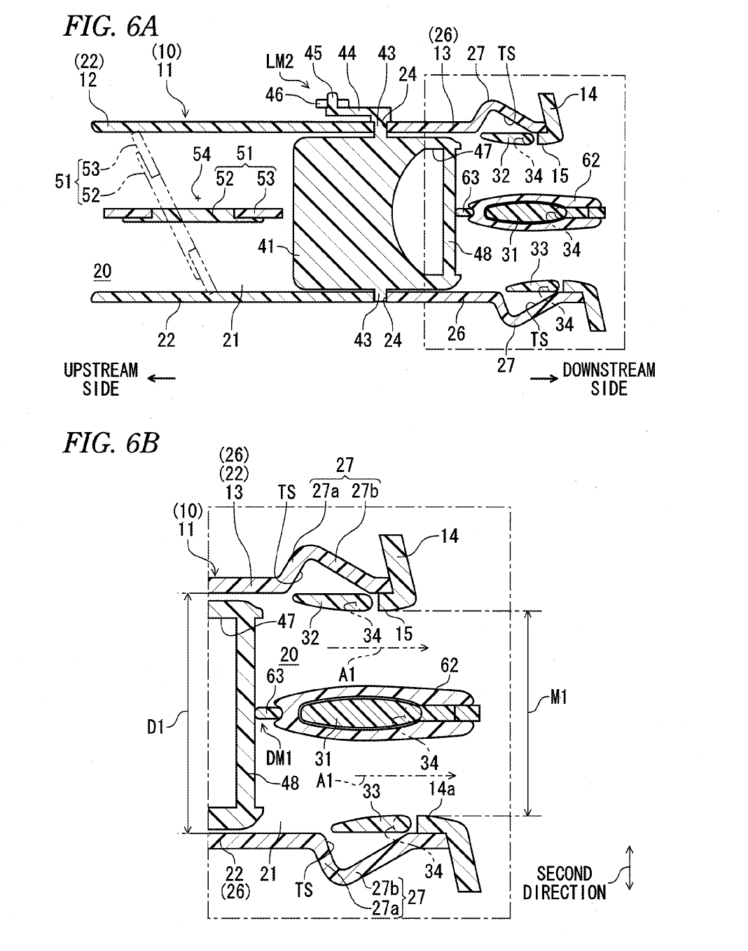

As shown in FIGS. 3, 6A and 6B, the downstream side fin group includes a downstream side main fin (which is hereinafter called a main fin) 31 and a pair of upper and lower downstream side auxiliary fins (which are hereinafter called auxiliary fins) 32, 33. The main fin 31 and two auxiliary fins 32, 33 are respectively formed of an oblong plate-shaped member extending in the first direction within the ventilation passage 20.

The ventilation-direction dimensions (widths) of the auxiliary fins 32, 33 are set smaller than that of the main fin 31.

The upper auxiliary fin 32, in the second direction, is disposed just below the upper second wall 22. The lower auxiliary fin 33, in the second direction, is disposed just above the lower second wall 22. The main fin 31 is disposed substantially centrally in the second direction, that is, centrally between the auxiliary fins 32 and 33.

From the respective end faces of the main fin 31 and auxiliary fins 32, 33 in the first direction, there are outwardly projected fin shafts 34 in the first direction. The fin shafts 34, in the ventilation direction, are disposed on the respective downstream ends of the main fin 31 and auxiliary fins 32, 33, and are supported by the bearing parts 23 such that they can be inclined with respect to the first walls 21.

Here, the reason why the downstream side fin group is constituted of three fins (a main fin 31 and two auxiliary fins 32, 33) is that, in the ventilation passage 20 the vertical-direction dimension is small, the distance between the main fin 31 and its adjoining auxiliary fins 32, 33 can be increased as much as possible to thereby secure the passage of the air-conditioning air A1.

As shown in FIGS. 2, 3 and 5, in each of the main fin 31 and auxiliary fins 32, 33, at least one (in this embodiment, one) of the fin shafts 34 projects outwardly from its corresponding first wall 21. On the ends of such projecting fin shafts 34, there are provided arms 35 integrally therewith. The arms 35 extend toward upstream from the fin shafts 34 and have connecting shafts 36 in their extended ends.

The connecting shafts 36 of the arms 35 are connected to each other by a connecting rod 37. The arms 35, connecting shafts 36, connecting rod 37 and the like constitute a link mechanism LM1 which mechanically connects the main fin 31 and auxiliary fins 32, 33 and inclines the auxiliary fins 32, 33 similarly to and synchronously with the main fin 31.

### <Upstream Side Fin Group>

As shown in FIGS. 4 and 5, the upstream side fin group is constituted of multiple upstream side fins arranged upstream of the downstream side fin group within the ventilation passage 20. The upstream side fins are respectively made of plate-shaped members extending in the second direction within the ventilation passage 20. The multiple upstream side fins, in the first direction, are arranged substantially parallel to each other and are spaced from each other substantially at regular intervals.

Here, in order to distinguish the multiple upstream side fins, fins situated substantially centrally in the first direction are called upstream side fins 41, while others are called upstream side fins 42.

From both end faces of the respective upstream side fins 41 and 42 in the second direction, fin shafts 43 are projected outward in the second direction. The fin shafts 43, in the ventilation direction, are respectively situated substantially in the central portions of the upstream side fins 41 and 42. The fin shafts 43 of the upstream side fins 41 and 42 are supported by the bearing parts 24 such that they can be inclined with respect to the second walls 22.

As shown in FIGS. 4 and 6A, in each of the upstream side fins 41 and 42, at least one (in this embodiment, upper) of the fin shafts 43 projects outward from the corresponding upper side second wall 22. On the ends of the projecting fin shafts 43, there are provided arms 44 integrally therewith. The arms 44 respectively extend toward upstream from the fin shafts 43 and have connecting shafts 45 on the extending ends thereof. The connecting shafts 45 of the arms 44 are connected to each other by a connecting rod 46. And, the arms 44, connecting shafts 45, connecting rod 46 and the like constitute a link mechanism LM2 which inclines all the upstream side fins 42 synchronously with the upstream side fins 41 such that they can be inclined similarly to the upstream side fins 41.

### <Shut Damper 51>

As shown in FIGS. 5 and 6, the shut damper 51 is used to open and close the ventilation passage 20 upstream of the upstream side fin group within the case 11. It includes a rectangular plate-shaped damper plate 52 longer in the first direction than in the second direction, and a seal member 53 mounted on the periphery of the damper plate 52.

From the two end faces of the damper plate 52 in the first direction, there are projected shafts 54 (see FIGS. 1 and 2) outwardly in the first direction. The two shafts 54 of the shut damper 51 are supported on the first wall 21 by the two bearing parts 25, whereby the shut damper 51 can be inclined between an open position and a closed position. The shut damper 51, at the open position, as shown by solid lines in FIG. 6A, substantially in the central portion thereof between the upper and lower second walls 22, is substantially parallel to these second walls 22 to thereby open the ventilation passage 20 greatly. The shut damper 51, at the closed position, as shown by two-dot chain lines in FIG. 6A, is inclined with respect to the upper and lower second walls 22 and, in the seal member 53, is contacted with the inner wall surfaces of the first and second walls 21 and 22, thereby closing the ventilation passage 20.

### <Operation Knob 62>

As shown in FIGS. 1 and 5, the operation knob 62 is a member which, when changing the blow-out direction of the air-conditioning air A1 from the blow-out opening, is operated by an occupant. It is fitted with the upper surface of the main fin 31 such that it can slide in the first direction. It can be inclined together with the main fin 31 with the two fins 34 as the fulcrum and, when sliding on the main fin 31, it can be shifted in the first direction.

### <Transmission Mechanism DM1>

The transmission mechanism DM1 transmits the slide operation of the operation knob 62 to the upstream side fins 41 to incline them with the two fin shafts 43 as their fulcrums.

As shown in FIGS. 4 and 5, each upstream fin 41 has a cut-out portion 47 extending upstream from the downstream end edge thereof. The cut-out portion 47 includes in its downstream end a transmission shaft section 48 extending in the second direction.

As shown in FIGS. 3 and 5, a fork 63 is connected to the upstream end of the operation knob 62. The fork 63, in a pair of support shafts 64 arranged on the downstream end thereof, is pressed into the upstream end of the operation knob 62. It can be inclined with the two support shafts 64 as its fulcrum. It includes in its upstream portion a pair of transmission pieces 65 extending upstream, while the two transmission pieces 65 hold therebetween the transmission shaft portions 48 of the upstream side fins 41.

Here, the cut-out portion 47 is used to avoid such interference with the two transmission pieces 65 as can be caused by the inclination of the upstream side fins 41. The cut-out portion 47 and transmission shaft portions 48 are not formed in the upstream side fin 42.

Thus, when the operation knob 62 is slid in the first direction along the main fin 31, a force in the first direction is applied to the upstream side fins 41 through the fork 63 and transmission shaft portions 48, thereby inclining the upstream side fins 41 with the two fin shafts 43 as their fulcrums.

The foregoing structure is the basic structure of the air conditioning thin register 10 of the embodiment.

In addition to the basic structure, in this embodiment, as shown in FIGS. 2 and 6A, most of the second walls 22 except for their downstream portions are constituted of two flat ordinary wall portions 26. The ordinary wall portions 26 are parallel to each other. The downstream portions of the second walls 22 are constituted of swelling wall portions 27 swelling away from the ventilation passage 20. The swelling wall portions 27 are formed in the portions the upstream ends of which come near to the upstream ends of the auxiliary fins 32, 33 when the auxiliary fins 32, 33 are parallel to the ordinary wall portions 26. The swelling wall portions 27 include upstream side inclination sections 27a constituting the upstream portions thereof and downstream side inclination sections 27b constituting the downstream portions. The upstream side inclination sections 27a are inclined such that, as they go downstream, they are remoter in the second direction from the ordinary wall portions 26. The downstream side inclination sections 27b are inclined such that, as they go downstream, they approach the ordinary wall portions 26. Spaces surrounded by the upstream side inclination sections 27a and downstream side inclination sections 27b, in other words, the internal spaces of the swelling wall portions 27 constitute inclination spaces TS which allow the auxiliary fins 32, 33 to incline from the ordinary wall portions 26 more outwardly of the ventilation passage 20 than the ordinary wall portions 26.

The paired auxiliary fins 32 and 33 are supported to be inclinable with respect to the first wall 21 between the blow-out opening 15 and second wall 22. More specifically, from such two portions of the bezels 14 as exist around the blow-out opening 15 and are opposed to each other at least in the second direction, there are projected toward upstream projecting portions 14a. The fin shafts 34 of the auxiliary fins 32 and 33 are disposed near upstream of the projecting portions 14a. The auxiliary fins 32 and 33 are set parallel to the ordinary wall portions 26 in the boundary with the ventilation passage 20 of the inclination spaces TS when the main fin 31 is set parallel to the ordinary wall portions 26.

In this embodiment, as shown in FIG. 6B, the dimension M1 of the blow-out opening 15 in the second direction and the distance D1 between the paired ordinary wall portions 26 are set equal or approximate to each other. As described above, the distance D2 (see FIG. 5) between the first walls 21 is uniform everywhere in the flow direction of the air-conditioning air A1. Thus, the above setting can also be expressed such that the passage area of the blow-out opening 15 and the passage area of the ordinary wall portions are set equal or approximate to each other.

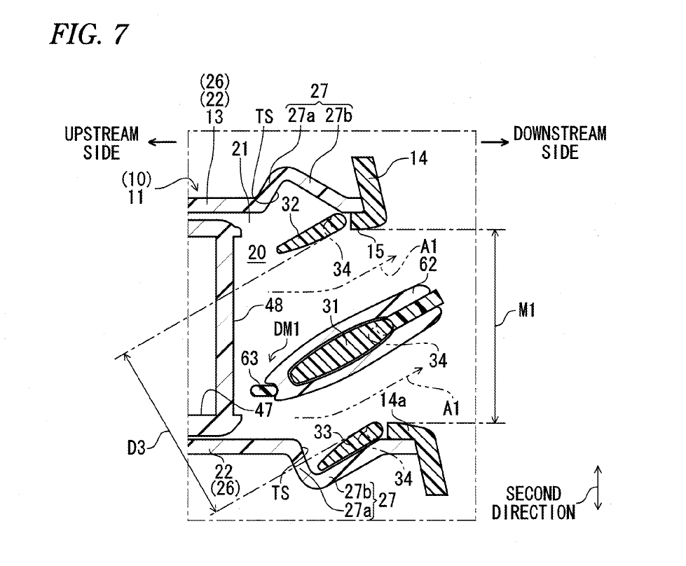

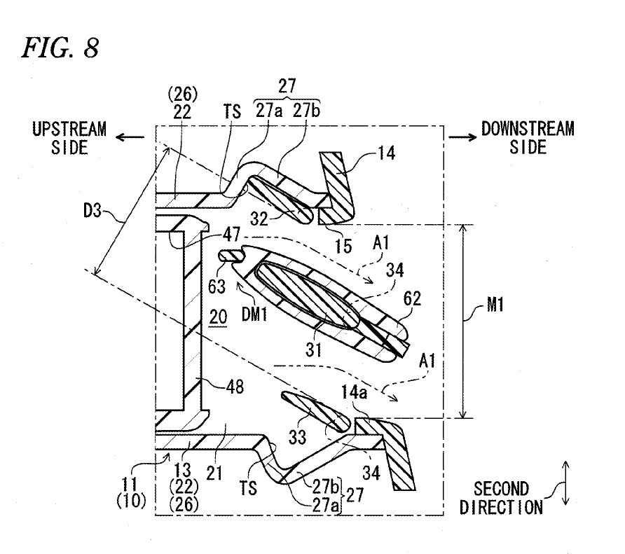

In this embodiment, as shown in FIGS. 7 and 8, the distance D3 between the auxiliary fins 32 and 33 when the main fin 31 is inclined by a maximum limit angle is set equal or approximate to a maximum limit value.

The air conditioning thin register 10 of the embodiment is structured in the above manner. Next, description is given of the operation of the air conditioning thin register 10.

Two-dot chain lines of FIG. 6A show a state where the shut damper 51 is situated at its closed position. In this state, the ventilation passage 20 is closed by the shut damper 51, thereby preventing the air-conditioning air A1 from flowing downstream of the shut damper 51 and thus stopping the blow-out of the air-conditioning air A1 from the blow-out opening 15.

Meanwhile, solid lines of FIG. 6A show a state where the shut damper 51 is situated at its open position. In this state, the ventilation passage 20 is opened full and the air-conditioning air A1 flows while branching to the upper and lower sides of the shut damper 51. The air-conditioning air A1 having passed the shut damper 51 flows along the upstream side fin group and downstream side fin group and then blows out from the blow-out opening 15.

Switching of the shut damper 51 from the closed position to the open position and vice versa is carried out through the rotational operation of an operation dial 55 (see FIG. 5) supported on the bezel 14. When the operation dial 55 is rotationally operated by an occupant, the rotation is transmitted through a damper drive mechanism (not shown) to the shut damper 51, whereby the shut damper 51 is inclined with the shaft 54 as the fulcrum.

Here, the following description presupposes that the shut damper 51 is held at the open position.

FIGS. 6A and 6B show the air conditioning thin register 10 when the main fin 31 is parallel (substantially parallel) to the two upper and lower ordinary wall portions 26. In this case, the auxiliary fins 32 and 33 are parallel to the ordinary wall portions 26 of the second wall 22 in their portions close to the second wall 22, more specifically, in their boundary portions with the ventilation passage 20 of the inclination space TS.

Part of the air-conditioning air A1 having passed the shut damper 51, in the passage between the main fin 31 and auxiliary fins 32, 33, flows along the main fin 31 and auxiliary fins 32, 33 and then blows out straight from the blow-out opening 15 toward the downstream side. In this case, the area of the passage between the main fin 31 and auxiliary fins 32, 33 provides a maximum limit value.

Also, in this case, the upstream ends of the auxiliary fins 32, 33 are situated near to the upstream ends of the swelling wall portions 27. The inclination spaces TS are closed by the auxiliary fins 32, 33 in the boundary portions with the ventilation passage 20. Clearances between the auxiliary fins 32, 33 and the ordinary wall portions 26 of the second wall 22 are small, while a little amount of the air-conditioning air A1 flows through such clearances into the inclination spaces TS.

Here, since the main fin 31 and auxiliary fins 32, 33 are all parallel to the second wall 22, ventilation resistance generated by them becomes smallest. This ventilation resistance depends on the difference between the dimension M1 of the blow-out opening 15 in the second direction and the distance D1 between the two ordinary wall portions 26. However, in this embodiment, as described above, the dimension M1 of the blow-out opening 15 and the distance D1 between the ordinary wall portions 26 are set equal or approximate to each other, whereby the difference between them (M1, D1) is small. Thus, an increase in the ventilation resistance, which is caused by sudden reduction of the passage area when the air-conditioning air A1 flows along the main fin 31 and auxiliary fins 32, 33, is hard to occur, thereby reducing pressure loss.

Also, in this case, the auxiliary fins 32, 33, while they are parallel to the ordinary wall portions 26, are situated in the upstream vicinity of the projecting portions 14a between the blow-out opening 15 and second wall 22. Therefore, when the air conditioning thin register 10 is viewed from downstream side, the peripheral portions (projecting portions 14a) of the blow-out opening 15 are situated in front of the auxiliary fins 32, 33, whereby these fins hide behind such portions (projecting portions 14a).

In the above state shown in FIGS. 6A and 6B, when an upward force is applied to the operation knob 62, as shown in FIG. 7, the main fin 31 is inclined counterclockwise with the fin shaft 34 as the fulcrum. The main fin 31 is inclined such that its height decreases toward upward. Also, the above inclination of the main fin 31 is transmitted to the auxiliary fins 32 and 33 by the link mechanism LM1 (FIGS. 1 and 2), whereby the auxiliary fins 32 and 33 are inclined similarly to and synchronously with the main fin 31. Consequently, the upper auxiliary fin 32 remote from the upstream end of the main fin 31 decreases in height toward upward, that is, it is inclined to be downwardly remoter from the swelling wall portion 27 of the upper second wall 22. Most of the lower auxiliary fin 33 existing near to the upstream end of the main fin 31 enters the inclination space TS within the swelling wall portion 27 of the lower second wall 22 and is inclined such that it lowers in height toward upward. In this state, the lower auxiliary fin 33 approaches the downstream side inclination section 27b of the lower swelling wall portion 27.

Since the air-conditioning air A1 flowing through the ventilation passage 20 flows along the main fin 31 and two auxiliary fins 32, 33, while the direction thereof is changed obliquely upward, it blows out from the blow-out opening 15.

In the above state, when a downward force is applied to the operation knob 62, the respective parts carry out their operations reverse to the above operations and thus the main fin 31 and two auxiliary fins 32, 33 are returned back to be substantially parallel to the second wall 22.

Also, in the state shown in FIGS. 6A and 6B, a downward force is applied to the operation knob 62, as shown in FIG. 8, the main fin 31 is inclined clockwise with the fin shaft 34 as the fulcrum. The main fin 31 is inclined such that its height increases toward upward. Also, the above inclination of the main fin 31 is transmitted to the auxiliary fins 32 and 33 by the link mechanism LM1 (FIGS. 1 and 2), whereby the auxiliary fins 32 and 33 are inclined similarly to and synchronously with the main fin 31. Consequently, the lower auxiliary fin 33 remote from the upstream end of the main fin 31 decreases in height toward upward, that is, it is inclined to be upwardly remoter from the swelling wall portion 27 of the lower second wall 22. Most of the upper auxiliary fin 32 existing near to the upstream end of the main fin 31 enters the inclination space TS within the swelling wall portion 27 of the upper second wall 22 and is inclined such that it increases in height toward upward. In this state, the upper auxiliary fin 32 approaches the downstream side inclination section 27b of the upper swelling wall portion 27.

The air-conditioning air A1 flowing through the ventilation passage 20, while its direction is changed obliquely downward when it flows along the main fin 31 and two auxiliary fins 32, 33, blows out from the blow-out opening 15.

In the above state, when an upward force is applied to the operation knob 62, the respective parts carry out their operations reverse to the above operations and thus the main fin 31 and two auxiliary fins 32, 33 are returned back to be substantially parallel to the second wall 22.

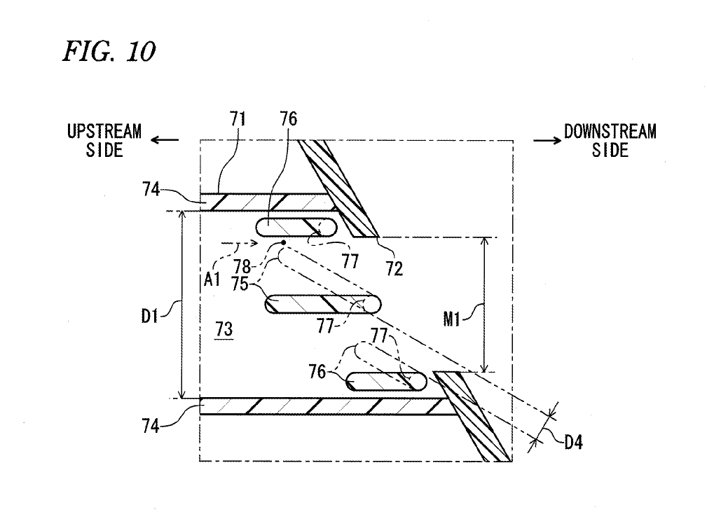

Therefore, unlike the structure that the auxiliary fin 76 existing near to the upstream end of the main fin 75 is set parallel to the upper and lower walls 74 (see FIG. 10), the vertical-direction dimension of the passage between the auxiliary fins 32, 33 and main fin 31 is large. Therefore, when the air-conditioning air A1 passes through the passage between the main fin 31 and auxiliary fins 32, 33 existing near to the upstream end thereof, the ventilation resistance is hard to increase.

The passage area of the passage between the main fin 31 and auxiliary fins 32, 33 decreases as the inclination angle of these fins with respect to the ordinary wall portions 26 increases. However, since the distance D3 between the two auxiliary fins 32 and 33 when the main fin 31 is inclined by a maximum limit angle is set equal or approximate to a maximum limit value, a wide passage can be secured between the main fin 31 and auxiliary fins 32, 33. Also when the main fin 31 is inclined by a maximum limit angle, the ventilation resistance of the air-conditioning air A1 when it passes through the passage between the main fin 31 and auxiliary fins 32, 33 is small.

In this case, since the auxiliary fins 32 and 33 are both inclined similarly to the main fin 31, when compared with the structure that one auxiliary fin 76 is set parallel to the upper and lower walls 74 (see FIG. 10), the air-conditioning air A1 is easy to flow in a direction similar to that of the main fin 31, thereby enhancing the directivity of the air-conditioning air A1.

Here, in FIG. 5, when a force going toward the first direction is applied to the operation knob 62, the operation knob 62 slides in the first direction on the main fin 31. Also, the force applied to the operation knob 62 is transmitted through the fork 63 to the transmission shaft portion 48 of the central upstream side fin 41. The upstream side fin 41 is inclined in the first direction with the shaft 43 as the fulcrum, specifically, toward the side where the operation knob 62 has been operated. In this case, the transmission shaft portion 48 turns around the fin shaft 43. The movement of the upstream side fin 41 with the fin shaft 43 as the fulcrum is transmitted to the other upstream side fin 42 through the arm 44, connecting shaft 45 and connecting rod 46 shown in FIGS. 1, 4 and the like. Due to this transmission, all upstream side fins 42 are inclined to the operated side of the operation knob 62 synchronously with the upstream side fin 41. The air-conditioning air A1 flows along the above-inclined upstream side fins 41 and 44, whereby, while its direction is changed, it blows out from the blow-out opening 15.

According to the specifically described embodiment, the following effects can be provided.

(1) In the downstream portions of the upper and lower second walls 22, there are formed swelling portions 27 swelling in a direction to part away from the air passage 20. A space surrounded by the swelling wall portions 27 is used to form an inclination space TS which allows the auxiliary fins 32 and 33 to incline more outwardly of the ventilation passage 20 than the ordinary wall portions 26 of the second walls 22. Further, the dimension M1 of the blow-out opening 15 in the second direction and the distance D1 between the paired ordinary wall portions 26 are set equal or approximate to each other (FIGS. 6A and 6B).

Therefore, when the main fin 31 and auxiliary fins 32, 33 are parallel to the ordinary wall portions 26 of the second walls 22 (FIG. 6B) and also when they are inclined (FIGS. 7 and 8), the ventilation resistance can be reduced and thus the pressure loss can be reduced.

(2) From the two portions of the bezel 14 which exist around the blow-out opening 15 and are opposed to each other at least in the second direction, there are projected toward upstream the projecting portions 14a. And, the fin shafts 34 of the auxiliary fins 32 and 33 are disposed in the upstream vicinity of the projecting portions 14a. Thus, the paired auxiliary fins 32 and 33 are supported to be inclinable with respect to the first wall 21 between the blow-out opening 15 and second wall 22 (FIG. 6B).

Therefore, when the air conditioning thin register 10 is viewed from the downstream side, the auxiliary fins 32 and 33 are hard to see, thereby enabling enhancement of the appearance of the register.

(3) When the main fin 31 is set parallel to the ordinary wall portions 26, the auxiliary fins 32 and 33 are set parallel to such ordinary wall portions 26 in their boundaries with the ventilation passage 20 of the inclination space TS (FIG. 6B).

Therefore, when the main fin 31 is set parallel to the ordinary wall portions 26, the air-conditioning air A1 can be prevented from flowing into the inclination space TS.

Also, in this case, the upstream ends of the auxiliary fins 32 and 33 are positioned in portions adjacent to the upstream ends of the swelling wall portions 27, whereby the clearance between them is narrowed. This can further prevent the air-conditioning air A1 from flowing into the inclination space TS.

(4) The distance D3 between the auxiliary fins 32 and 33 when the main fin 31 is inclined by a maximum limit angle is set equal or approximate to a maximum limit value (FIGS. 7 and 8).

Therefore, even when the main fin 31 is inclined by a maximum limit angle, when the air-conditioning air A1 passes through the passage between the main fin 31 and auxiliary fins 32, 33, the ventilation resistance thereof can be reduced and thus the pressure loss can be reduced.

Here, the above embodiment can also be enforced as a modification in which the embodiment is changed in the following manner.

### <Downstream Side Fin Group>

The auxiliary fins 32 and 33 may only be inclined similarly to and synchronously with the main fin 31. Thus, they may not always be strictly parallel to the main fin 31.

The downstream side fin group may also be constituted of a pair of auxiliary fins 32, 33 and multiple main fins 31 interposed between them.

### <Application Portion>

The above air conditioning thin register 10 can also be applied to an air conditioning thin register 10 to be provided on the other portion of the vehicle room than the instrument panel.

The application of the above air conditioning thin register 10 is not limited to a vehicle but it can be applied widely, so long as the direction of the air-conditioning air A1 supplied from an air conditioner and blown into a room can be adjusted by fins.

### <Others>

The above air conditioning thin register 10 can also be applied to an air conditioning thin register 10 which is arranged such that the blow-out opening 15 is vertically long. In this case, the vertical direction provides a first direction, while the vehicle width direction provides a second direction. In the case 11, the mutually opposed walls in the vertical direction provide first walls 21, while the mutually opposed walls in the vehicle width direction provide second walls 22. The main fin 31 and auxiliary fins 32, 33 are arranged in the vehicle width direction, while the upstream side fins 41 and 42 are arranged in the vertical direction.

Parts and portions having no direct relation to the characteristics of the invention such as the upstream side fins 41, 42 and shut damper 51 may also be changed properly, for example, they may be omitted, or the shapes and number thereof may be changed.

What is claimed is:

1. An air conditioning thin register comprising:
a case formed of a pair of first walls opposed to each other in a first direction and a pair of second walls opposed to each other in a second direction into a cylindrical shape with its dimension in the first direction larger than its dimension in the second direction, having an internal space serving as the ventilation passage for an air-conditioning air, and including in the downstream end thereof a blow-out opening for the air-conditioning air;
a pair of auxiliary fins provided in portions of the interior of the case which are adjacent to the second walls, extending in the first direction and supported to be inclinable with respect to the first walls; and
a main fin extending in the first direction between the paired auxiliary fins and supported to be inclinable with respect to the first walls, the two auxiliary fins being inclined similarly to and synchronously with the main fin, wherein
the second walls respectively include in their downstream portions swelling wall portions swelling in a direction to go away from the ventilation passage, a space surrounded by the swelling wall portions constitutes an inclination space allowing the auxiliary fins to incline more outwardly of the ventilation passage than ordinary wall portions constituting the portions of the second walls existing more upstream of the swelling wall portions; and
the dimension of the blow-out opening in the second dimension and the distance between the ordinary wall portions of the paired second walls are set equal or approximate to each other.

2. The air conditioning thin register according to claim 1, wherein
the auxiliary fins are supported such that they can be inclined with respect to the first walls between the blow-out opening and the second walls.

3. The air conditioning thin register according to claim 2, wherein
when the main fin is set parallel to the ordinary wall portions, the auxiliary fins are set parallel to the ordinary wall portions in boundaries with the ventilation passage of the inclination space.

4. The air conditioning thin register according to claim 1, wherein
when the main fin is inclined by a maximum limit angle, the distance between the two auxiliary fins is set equal or approximate to a maximum limit value.
